(19) United States
(12) Patent Application Publication
(10) Pub. No.: US 2014/0355902 A1
(43) Pub. Date: Dec. 4, 2014

(54) IMAGE PROCESSING METHOD WITH DETAIL-ENHANCING FILTER WITH ADAPTIVE FILTER CORE

(71) Applicant: FLIR Systems AB, Taby (SE)

(72) Inventor: Stefan Olsson, Stockholm (SE)

(21) Appl. No.: 14/464,531

(22) Filed: Aug. 20, 2014

Related U.S. Application Data
(63) Continuation of application No. PCT/SE2013/000019, filed on Feb. 11, 2013.

(30) Foreign Application Priority Data
Feb. 21, 2012 (SE) 1230022-4

(51) Int. Cl. G06T 5/20; G06T 5/00

(52) U.S. Cl. CPC G06T 5/20; G06T 5/002; G06T 5/003; G06T 2207/20024
USPC 382/261

(57) ABSTRACT

One or more embodiments of the invention relate to an image processing system and method for filtering with an adaptive filter core size, the method including: an original image is created, an information measure is calculated on the basis of the original image, a filter core size is calculated on the basis of the information measure, the original image is low-pass filtered with an adaptive low-pass filter with the filter core size to form a low-pass filtered image, a high-pass filtered image is calculated by subtracting the low-pass filtered image from the original image, a detail-enhanced image without light rings is obtained by a high-pass image scaled with a detail enhancement measure being added to the low-pass image. Embodiments additionally relate to an image processing device having an image recording device, an image processing unit, and an image display unit.

### CROSS-REFERENCE TO RELATED APPLICATIONS

This application is a continuation of International Patent Application No. PCT/SE2013/000019 filed Feb. 11, 2013 and entitled “IMAGE PROCESSING METHOD WITH DETAIL-ENHANCING FILTER WITH ADAPTIVE FILTER CORE” which is hereby incorporated by reference in its entirety.

International Patent Application No. PCT/SE2013/000019 claims the benefit of Swedish Patent Application No. SE 1230022-4 filed Feb. 21, 2012, which is hereby incorporated by reference in its entirety.

### TECHNICAL FIELD

One or more embodiments of the present invention relate to an image processing method including filtering, with adaptive filter core size, of an image. In addition, one or more embodiments of the invention relate to an image processing device including an image recording device, an image processing unit and an image display unit.

### BACKGROUND

Various solutions for image processing, such as, for example, various forms of filtering or enhancement of details, are well-known techniques for improving the visualization of a recorded image. Various types of compression of image information are also known, partly in order to reduce the information content of the image and thus obtain images with smaller information quantity, but also in order to adapt the image for the viewer of the image. A human has a limited capacity as a viewer to differentiate between both details and different colours and grey scales.

Systems for recording and displaying images taken in conditions where no daylight is present have used various forms of image processing to improve the information content of the recorded image. Image processing is preferably realized by mathematical methods on a digital representation of the information content of the recorded image. It is common practice that details and edges in the recorded image are enhanced. The imaging processing methods which are currently available for edge enhancement often create a phenomenon which can be referred to as light ring or halo. These light rings or halos disturb the image and it becomes harder to visualize objects. These disturbances arise, moreover, in image sections in which there is a large difference in contrast, which means that the disturbance arises in regions in which there may be interesting information which, when visualized, is difficult to interpret.

One example of image recording when the light conditions are such that it is difficult to use normal optical equipment is the use of IR video or IR photography, in which IR stands for infrared. Details and structure in IR video are normally constituted by small variations in signal strength within a local region. At the same time, the total dynamic range in a single image can be large. The difference in signal level between a cold region and a warm region can result in about 65,000 grey levels being able to be recorded. Typically this signal will be compressed so that its total dynamic range becomes 8 bits or 256 distinct grey levels from black to white in order to fit the video format and be better suited for presentation to an operator. The reason for this is an adaptation to different video standards and that a human can only differentiate between around 100 grey levels. A purely linear compression of the signal is almost always unsuitable, since a small region with widely differing signal level is at risk of using all the dynamic range, whereupon an image having, in principle, just a few colour and grey scale levels is obtained.

A common way of getting round this is to utilize the histogram of the image (distribution of signal levels) and, based on this, determine suitable conversion, from 16 to 8 bits, for example, so that the available dynamic is not spent or used at levels at which there is no signal. Even though histogram equalization is very effective in many contexts, it is generally difficult to foresee whether the correct details will actually be accentuated. For this, other methods which give more robust results are used. One such method is to use an edge-preserving low-pass filter to produce a background image without details or structure and subtract this image from the original image in order thereby to produce the small signal variations in which the small signal variations are constituted by the details.

Edge-preserving low-pass filters are previously known and an example of such a filter is described in C. Tomasi and R. Manduchi, Bilateral Filtering for Gray and Color Images, Proc. 1996 IEEE 6th. Int. Conf. on Computer Vision, Bombay, India. By replacing the value of each image point with the mean value of the values of neighbouring image points, a smooth image is obtained. If non-edge-preserving filters are used, image points having neighbours with widely differing signal intensity will be affected, so that they end up at a higher or lower level than they actually should.

Adaptive filters, too, are known, and an example of such a filter is described in J. Xie, P. Heng and M. Shah, Image Diffusion Using Saliency Bilateral Filter, IEEE Transactions on Information Technology in Biomedicine, Vol. 12, Issue 6, 2008.

A problem with the currently known methods for detail enhancement and filtering of image information is that, when edge enhancement is used, then disturbing light rings or halo formations usually arise on the filtered images.

### SUMMARY

One or more embodiments of the present invention are directed to a method for filtering image information, so that, when an image is edge-enhanced, then the filtering will be realized with an adaptive filter core size in order to avoid the creation of light rings or halo formations. Other embodiments of the invention are described in greater detail in connection with the detailed description of the embodiments of the invention.

One or more embodiments of the present invention relate to an image processing method for filtering with an adaptive filter core size, the method including:

(a) an original image is created;

(b) an information measure is calculated on the basis of the original image;

(c) a filter core size is calculated on the basis of the information measure;

(d) the original image is low-pass filtered with an adaptive low-pass filter with filter core size to form a low-pass filtered image;

(e) a high-pass filtered image is calculated by subtracting the low-pass filtered image from the original image;

(f) a detail-enhanced image without light rings is obtained by a high-pass image scaled with a detail enhancement measure being added to the low-pass image.

According to further embodiments of the improved image processing method for filtering with an adaptive filter core size:

the low-pass filtered image is compressed with a compression algorithm;

the filter core size is chosen on the basis of a look-up table with input data from the information measure;

the filter core size is calculated on the basis of a core size algorithm with input data from the information measure;

the information measure is an edge information measure;

the edge information measure is calculated with a Sobel operator;

the information measure is a spread measure;

the spread measure is a standard deviation;

the information measure is an entropy measure;

the detail enhancement measure is a variable enhancement measure;

the detail enhancement measure is a dynamic algorithm.

One or more embodiments of the invention are further constituted by an image processing device including an image recording device, an image processing unit, and an image display unit, in which:

(a) the recording device creates an original image;

(b) an image processing unit calculates an information measure on the basis of the original image;

(c) an image processing unit calculates a filter core size on the basis of the information measure;

(d) the image processing unit low-pass filters the original image with an adaptive low-pass filter with filter core size to form a low-pass filtered image;

(e) the image processing unit calculates a high-pass filtered image by subtracting the low-pass filtered image from the original image;

(f) the image processing unit calculates a detail-enhanced image without light rings by adding a high-pass image scaled with a detail enhancement measure to the low-pass image;

(g) the image display unit visualizes the detail-enhanced image without light rings.

According to further embodiments of the improved image processing device according to one or more embodiments of the invention:

the image recording device is an IR camera;

the image processing unit compresses the low-pass filtered image with a compression algorithm;

the filter core size is chosen in the image processing unit on the basis of a look-up table with input data from the information measure;

the filter core size is calculated in the image processing unit on the basis of a core size algorithm with input data from the information measure;

the image processing unit calculates the information measure with a Sobel operator;

the image processing unit calculates the information measure by a standard deviation calculation of the original image;

the high-pass filtered image is scaled in the image processing unit with a detail enhancement measure, in which the detail enhancement measure is a variable enhancement measure;

the high-pass filtered image is scaled in the image processing unit with a detail enhancement measure, in which the detail enhancement measure is a dynamic algorithm.

The scope of the invention is defined by the claims, which are incorporated into this Summary by reference. A more complete understanding of embodiments of the invention will be afforded to those skilled in the art, as well as a realization of additional advantages thereof, by a consideration of the following detailed description of one or more embodiments. Reference will be made to the figures of the appended sheets of drawings that will first be described briefly.

### BRIEF DESCRIPTION OF THE DRAWINGS

Various embodiments of the present invention will be described in greater detail below with reference to the appended figures, in which:

FIG. 1 shows a block diagram for an image processing method for adaptive image filtering according to one or more embodiments of the invention.

FIG. 2 shows a block diagram for components in an image processing system according to one or more embodiments of the invention.

Embodiments of the invention and their advantages are best understood by referring to the detailed description that follows. It should be appreciated that like reference numerals are used to identify like elements illustrated in one or more of the figures.

### DETAILED DESCRIPTION

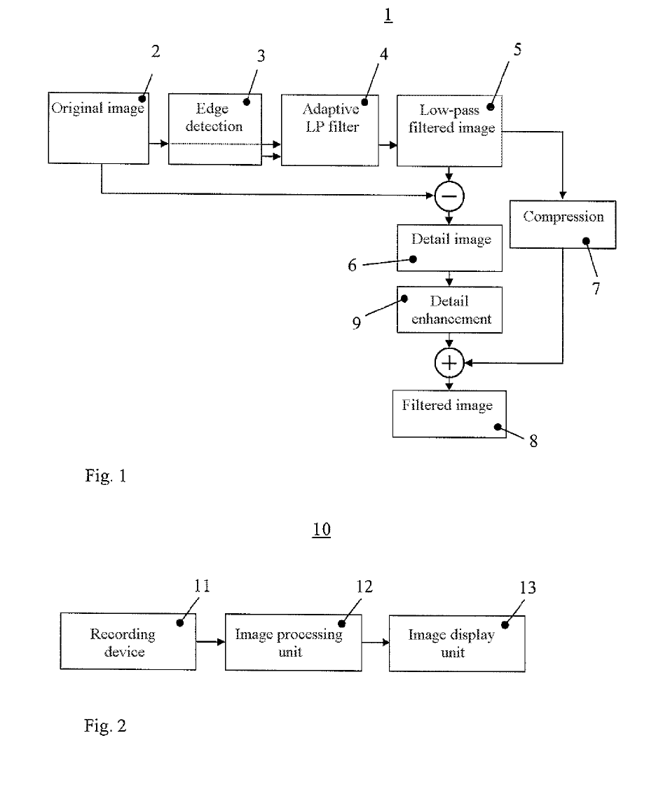

A block diagram for an image processing method for adaptive image filtering 1 according to one or more embodiments of the invention is shown in FIG. 1. The image processing method is based on a grouping of image information to form parts of the complete image, also referred to as the original image 2. The grouping of image information is preferably realized in the form of a 16-bit frame, in which the frame defines a set of digital information in the form of a number of digital bits. A complete digital image is divided into a large number of smaller groups or frames for easier image processing.

The image processing method for adaptive filtering 1 starts from an original image 2 which has been procured with suitable recording equipment, not further described in this application. A block having an edge-detecting function 3 calculates an information measure on the basis of the original image. The information measure describes the placement and level of an edge in the original image, or other values related to changes in the original image 2. The results from the edge-detecting function 3 are further processed by the adaptive low-pass filter or LP filter 4. Input values or control values for the adaptive low-pass filter 4 are an information measure created by the edge-detecting function 3, as well as image information from the original image 2. The result of the adaptive low-pass filter 4 is a low-pass filtered image 5. The low-pass filtered image is created by a signal processing or alternative modification of the original image 2 on the basis of the content in the information measure and the original image 2 in the low-pass filter 4. The information measure determines the size of the adaptive low-pass filter 4. The size of the adaptive low-pass filter 4 is also referred to as the core. The core size is determined on the basis of the distance from the edge and/or with the intensity on the edge. The core size is determined on the basis of the information measure by calculation or by reference to a table. Where the value is looked up in a table, also referred to as a look-up table, then a value in the look-up table is identified on the basis of the information measure. The look-up table has been calculated earlier and adapted on the basis of the application and the look-up table is stored in the image processing equipment, for example in an image processing unit 12. Alternatively, the core size can be calculated with a custom-made algorithm, referred to as a core size algorithm, with the information measure as input data to the core size algorithm. The low-pass filtered image is edge-enhanced and filtered with an adaptive filter, which has resulted in the image having well-defined contours without the occurrence of light rings, halo phenomenon or other disturbing formations or other deviations in the image.

The low-pass filtered image 5 is subtracted from the original image 2 to create a high-pass filtered image, also referred to as a detail image 6. The detail image 6 is an image in which details from the original image 2 are clarified by subtraction of the low-pass filtered image 5 from the original image 2. By adding the high-pass filtered image 6, weighted by the detail enhancement block 9, to the low-pass filtered image 5, a filtered image 8 can be created. The detail enhancement block 9 determines the level of how the detail image 6 is to be added to the low-pass filtered image S. The detail enhancement, which is determined in the detail enhancement block 9, can be a variable enhancement measure which can be specified by the user of the image processing method. This variable enhancement measure can, for example, be fed in, or otherwise specified, into or to an image processing unit 12. The detail enhancement can also be calculated in the detail enhancement block 9 on the basis of an algorithm developed and adapted for the purpose. The algorithm for the calculation of detail enhancement can, for example, identify and enhance details, sections, objects or regions or other formations in the low-pass filtered image 5, the detail image 6, or the original image 2, where a better enhancement is desirable. In the same way, the algorithm for the calculation of detail enhancement can suppress or otherwise reduce the importance of details, sections, objects or regions or other formations in the detail image 6.

The result after the detail image block 9 is added to the low-pass filtered image 5 to create a filtered image 8. The low-pass filtered image 5, before it is added to the detail image 6, can be dynamically compressed with an algorithm suitable for the purpose. The detail image 6 is added to the low-pass filtered image 5 linearly with a global scale factor, alternatively the detail image 6 is adapted pixel by pixel based on the information measure, or else the detail image 6 is added to the low-pass image 5 with a scale factor on the basis of the dynamic compression with which the detail image 6 has been compressed. The filtered image 8 is a detail-enhanced and possibly also noise-reduced image of the original image 2 without light rings or halo phenomenon. The low-pass filtered image 5 can be compressed with a suitable algorithm, for example histogram equalization, mainly in order to reduce the information content in the filtered low-pass image and thus also reduce the quantity of information from the original image. Compression takes place in a compression block 7. The filtered and compressed low-pass image preferably contains less information than the original image 2 and is tailored to the particular application and/or equipment, for example by reduction of the number of grey tones. Compression is realized with standard algorithms, which are not further touched upon in this application.

In FIG. 2 is shown a block diagram for one or more embodiments in an image processing system 10 according to one or more embodiments of the invention. The image processing system 10 consists of a recording device 11, which is an image collection unit and can be a camera or image sensor, an image processing unit 12, as well as an image display unit 13. The recording device 11 records an image of the target or region at which the image collection unit has been directed. The recording device 11 is preferably in this case an IR camera, but can also be other types of image-collecting equipment, such as cameras or sensors. The image processing unit 12 processes the image from the recording device 11 with algorithms suitable for the purpose. Examples of suitable algorithms are edge enhancement, compression, noise reduction and other types of filtering algorithms or image modification algorithms. In addition, the filtering algorithms can be scalable and the filter core or filter cores can be modifiable. The image processing is preferably carried out in microprocessors, and/or signal processors, including programmable electronics. The image processing unit 12 is thus constituted by a device for handling image information from the recording device 11, a device for image-processing the image information from the image collection unit, and a device for transferring the image-processed image information to an image display unit 13. The image display unit 13 can be constituted by a display or other optical visualization equipment adapted on the basis of the use and installation of the image processing system 10.

It will be appreciated that the above-described image processing method and/or the device for image recording, image processing and presentation of an image-processed image can in principle be applied to all image processing systems, such as TR cameras, cameras or other optical sensors for all conceivable wavelength ranges.

While the invention has been described in detail in connection with only a limited number of embodiments of the invention, it should be readily understood that the invention is not limited to such disclosed embodiments. Rather, the invention may be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims and functional equivalents thereof.

1. An image processing method for filtering with an adaptive filter core size, the method comprising:
(a) creating an original image;
(b) calculating an information measure based on the original image;
(c) calculating a filter core size based on the information measure;
(d) low-pass filtering the original image with an adaptive low-pass filter with the filter core size to form a low-pass filtered image;
(e) calculating a high-pass filtered image by subtracting the low-pass filtered image from the original image;
(f) obtaining a detail-enhanced image without light rings by adding the high-pass filtered image scaled with a detail enhancement measure to the low-pass filtered image.

2. The image processing method according to claim 1, wherein the low-pass filtered image is compressed with a compression algorithm.

3. The image processing method according to claim 1, wherein the filter core size is chosen based on a look-up table with input data from the information measure.

4. The image processing method according to claim 1, wherein the filter core size is calculated based on a core size algorithm with input data from the information measure.

5. The image processing method according to claim 1, wherein the information measure is an edge information measure.

6. The image processing method according to claim 5, wherein the edge information measure is calculated with a Sobel operator.

7. The image processing method according to claim 1, wherein the information measure is a spread measure.

8. The image processing method according to claim 7, wherein the spread measure is a standard deviation.

9. The image processing method according to claim 1, wherein the information measure is an entropy measure.

10. The image processing method according claim 1, wherein the detail enhancement measure is a variable enhancement measure.

11. The image processing method according claim 1, wherein the detail enhancement measure is a dynamic algorithm.

12. An image processing device comprising an image recording device, an image processing unit, and an image display unit, wherein:
the image recording device is configured to create an original image;
the image processing unit is configured to:
calculate an information measure based on the original image,
calculate a filter core size based on the information measure,
low-pass filter the original image with an adaptive low-pass filter with the filter core size to form a low-pass filtered image,
calculate a high-pass filtered image by subtracting the low-pass filtered image from the original image, and
calculate a detail-enhanced image without light rings by adding the high-pass filtered image scaled with a detail enhancement measure to the low-pass filtered image; and
the image display unit is configured to visualize the detail-enhanced image without the light rings.

13. The image processing device according to claim 12, wherein the image recording device is an IR camera.

14. The image processing device according to claim 12, wherein the image processing unit is further configured to compress the low-pass filtered image with a compression algorithm.

15. The image processing device according to claim 12, wherein the filter core size is chosen in the image processing unit based on a look-up table with input data from the information measure.

16. The image processing device according to claim 12, wherein the filter core size is calculated in the image processing unit based on a core size algorithm with input data from the information measure.

17. The image processing device according to claim 12, wherein the image processing unit is configured to calculate the information measure with a Sobel operator.

18. The image processing device according to claim 12, wherein the image processing unit is configured to calculate the information measure by a standard deviation calculation of the original image.

19. The image processing device according to claim 12, wherein the high-pass filtered image is scaled in the image processing unit with the detail enhancement measure, and wherein the detail enhancement measure is a variable enhancement measure.

20. The image processing device according to claim 12, wherein the high-pass filtered image is scaled in the image processing unit with the detail enhancement measure, and wherein the detail enhancement measure is a dynamic algorithm.
